(19) United States
(12) Patent Application Publication
(10) Pub. No.: US 2014/0188397 A1
(43) Pub. Date: Jul. 3, 2014

(54) Methods of acquiring genome size and error

(71) Applicant: BGI Tech Solutions Co., Ltd., Shenzhen (CN)

(72) Inventors: Wei Fan, Shenzhen (CN); Binghang Liu, Shenzhen (CN); Zhenyu Li, Shenzhen (CN); Jun Wang, Shenzhen (CN)

(73) Assignee: BGI TECH SOLUTIONS CO., LTD., Yantian District, Shenzhen (CN)

(21) Appl. No.: 14/118,109

(22) PCT Filed: May 17, 2011
(86) PCT No.: PCT/CN2011/000863

§ 371 Date: Nov. 15, 2013

(51) Int. Cl. G06F 19/10

(52) U.S. Cl. CPC G06F 19/10
USPC 702/19

(57) ABSTRACT

Provided is a method of acquiring genome size. The method comprises steps of sequencing random fragments of whole genome, acquiring all of k-mer information including k-mer depth, counting frequency of each k-mer depth value so as to determine expected k-mer depth, and acquiring the genome size by dividing the sum of k-mers by the expected k-mer depth. The method is convenient, rapid, and cost-effective. Also provided is a method of acquiring error of sequencing genome based on all of k-mer information including k-mer depth.

### FIELD

The present disclosure relates to a field of genetic engineering techniques, and more particularly to a method and a system of acquiring a genome size, and a method of estimating an error rate.

### BACKGROUND

In the genomic research, the basic but very important issue is what is the size of the genome (usually refers to haploid), i.e. what is total amount of DNA in this kinds of biological haploid germ cells. Hewson Swift proposed a concept of C-value in 1950, which refers to the DNA amount in haploid plants. Later, the scope of the concept of C-value has gradually expanded. Now, the size of whole biological genome can be represented by C-value. An initial view is that the genome size is proportional to complexity of species, i.e. the simpler species, the smaller size of the genome thereof; the more complex species, the bigger size of the genome thereof However, with further research and expansion, the accuracy of the above view has been increasingly questioned. It has been found that, even species belonging to the same category, the changes of genome size can also be very significant, while there may be little difference in the view of complexity among species. This is known as “C-value paradox”. In order to better understand a relationship between the species complexity and the genome size thereof, it becomes increasingly important to estimate the genome size accurately.

In recent years, with the support of rapid development of science and technology, a variety of cell-biological methods of estimating the genome size have been developed, such as Feulgen microscopic optical densitometry, flow cytometry and fluorescence quantitative method by using DAPI (4′, 6-diamidino-2-phenylindole) staining, etc., among which flow cytometry has been used broadly. However, these methods require a relative high level of laboratory equipment and biological experimental techniques without high accuracy. For example, Feulgen microscopic optical densitometry requires a relative high level of laboratory techniques, such as preparation of control slice, selection of fixatives, control of Hydrolysis time, the role of Schiff reagent, these are all key factors to the success of the above method, which results in low accuracy. Although there are many reports of determining the genome size by flow cytometry overseas, this method is still considerable controversy. Because there are too many factors that affect the determination, such as the selection of extraction and staining of the nucleus, as well as the selection of the reference. Particularly, there are no universally accepted standard of reference selection in recent, even using same species as a reference, it may appear differences of the genome size thereof among different varieties of the same species. While DAPI is a strongly carcinogen, and there are many affecting factors during experimental process which lead to low accuracy. Since the method of estimating the genome size by cell-biological method does not depend on real sequence by means of sequencing, the results of actual sequencing can just be a reference value.

### SUMMARY

One aspect of the present disclosure directs to solve at least one of the problems existing in the prior art to at least some extent, which provides a method and a system of acquiring a genome size, which can be conveniently achieved with low-cost.

According to a first broad aspect of the present disclosure, there is provided a method of preparing a genome size comprising:

subjecting a certain number of a genomic sequence obtained by sequencing a whole genome to k-mer-selection, to obtain all k-mer information and a depth information of k-mer;

obtaining a frequency of each depth value based on the k-mer information and the depth information of k-mer;

determining a desired depth of k-mer based on the frequency of each depth value;

determining the genome size G based on a total number of k-mer and the desired depth of k-mer:

$$G = \frac{{k}_{num}}{{k}_{depth}}$$

wherein kₙᵤₘ is the total number of k-mer, k_{depth} is the desired depth of k-mer.

According to a second broad aspect of the present disclosure, there is provided a system of acquiring a genome size comprising:

a k-mer information-obtaining apparatus, configured to subject a certain number of a genomic sequence obtained by sequencing a whole genome to k-mer-selection, to obtain all k-mer information and a depth information of k-mer;

a depth frequency-obtaining apparatus, configured to obtain a frequency of each depth value based on the k-mer information and the depth information of k-mer;

a desired depth-obtaining apparatus, configured to determine a desired depth of k-mer based on the frequency of each depth value;

a genome size-determining apparatus, configured to determining the genome size G upon a total number of k-mer and the desired depth of k-mer:

$$G = \frac{{k}_{num}}{{k}_{depth}}$$

wherein kₙᵤₘ is the total number of k-mer, k_{depth} is the desired depth of k-mer.

The method and the system of acquiring the genome size provided be embodiments of the present disclosure, may estimate the genome size by k-mer analysis method, of which the required resource is just sequence obtained by sequencing, and all analysis is performed based on a frequency list of the sequence obtained by sequencing and depth-frequency information, without requirements of extra laboratory techniques, which can be conveniently achieved with low-cost.

In addition, comparing with relative high requirement of laboratory equipment and biological laboratory techniques to the traditional method, and with greater influence of laboratory condition to the accuracy, the technical solution of the present disclosure may acquire more accurate estimating result of the genome size.

According a third broad aspect of the present disclosure, there is provided a method of estimating an error rate of sequencing a sequence, comprising

subjecting a certain number of a genomic sequence obtained by sequencing a whole genome to k-mer-interception, to obtain all k-mer information and a depth information of k-mer;

obtaining a frequency of k-mer having a depth value of 1;

determining the error rate f of sequencing the sequence based on following formula:

$$f = \frac{{n}_{1}}{{n}_{b} \times ɛ \times k}$$

wherein n₁ is the frequency of k-mer having the depth value of 1, n_{b} is the total number of bases, E is a probability value of error base produced by the error rate, k is the length of k-mer.

### BRIEF DESCRIPTION OF THE DRAWINGS

FIG. 1 shows a flow chart of a method of acquiring a genome size according to one embodiment of the present disclosure;

FIG. 2 shows a flow chart of a method of acquiring the genome size according to another embodiment of the present disclosure;

FIG. 3 shows a flow chart of a method of acquiring the genome size according to an application example of the present disclosure;

FIG. 4 shows a distribution diagram of k-mer depth shown in the applied example;

FIG. 5 shows a schematic diagram of a system of acquiring a genome size according to an embodiment of the present disclosure;

FIG. 6 shows a flow chart of a method of estimating an error rate of sequencing a sequence according to an embodiment of the present disclosure.

### DETAILED DESCRIPTION

Reference will be made in detail to embodiments of the present disclosure. The embodiments described herein with reference to drawings are explanatory.

In the present disclosure, k-mer refers to a base sequence having a predetermined length. k-mer may be different due to different base sequences. Each kind of k-mer having a different length sequence is known as one kind of k-mer, which appears one time or more in all k-mers obtained from step of subjecting genomic sequence to k-mer-selection. The appearance times of each kind of k-mer is known as a depth. The number of different kind of k-mer having a same depth is known as a frequency of the depth.

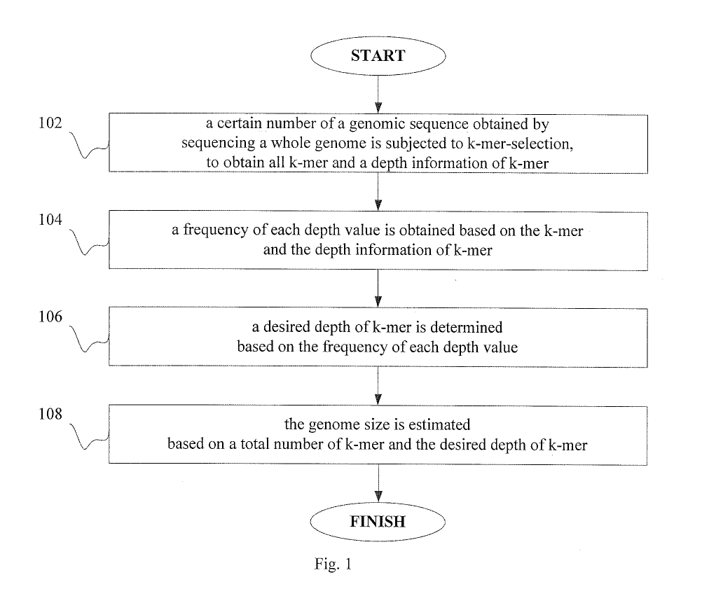

FIG. 1 shows that a flow charts of a method of acquiring a genome size according to the present disclosure.

As can be shown in FIG. 1, in step 102, a certain number of a genomic sequence obtained by sequencing a whole genome is subjected to k-mer-selection, to obtain all k-mer information and a depth information of k-mer. A certain number refers to average times being sequenced of each base in genome, for example, the average times being sequenced of each base is 10 to 20, 20 to 30, or 30 to 40, or more.

In step 104, a frequency of each depth value is obtained based on the k-mer information and the depth information of k-mer. In the case of the information of all k-mer kinds and depth value thereof being known, a number of k-mer kind corresponding to each depth may be calculated, which is the frequency of the depth value. For example, there are totally t kinds of k-mer having a depth value of m, the frequency corresponding to the depth value m is t.

In step 106, a desired depth of k-mer is determined based on the frequency of each depth value. For example, assuming

Assuming that the depth of k-mer distributed obeys the Poisson's distribution, the desired depth of k-mer may be determined according to the frequency information of each depth.

In step 108, a genome size G is determined based on a total number of k-mer and the desired depth of k-mer:

$$G = \frac{{k}_{num}}{{k}_{depth}}$$

in which kₙᵤₘ is the total number of k-mer, k_{depth} is the desired depth of k-mer. The total number of k-mer may be obtained by calculating k-mer.

In the above embodiments, all required resources for estimating the genome size by k-mer analysis method are only sequences obtained by sequencing; and all analysis are performed based on a frequency table of the sequences obtained by sequencing and a depth-frequency curve without extra requirements for experimental techniques. Comparing with relatively high requirements for experimental equipment and biological experimental techniques and relatively large influence to accuracy by the experimental condition of the conventional method, the current technical solution may obtain accurate results of the genome size estimation. The present disclosure may conveniently estimate the genome size, and the financial and material resources spent by the experimental technique in the traditional method will be saved.

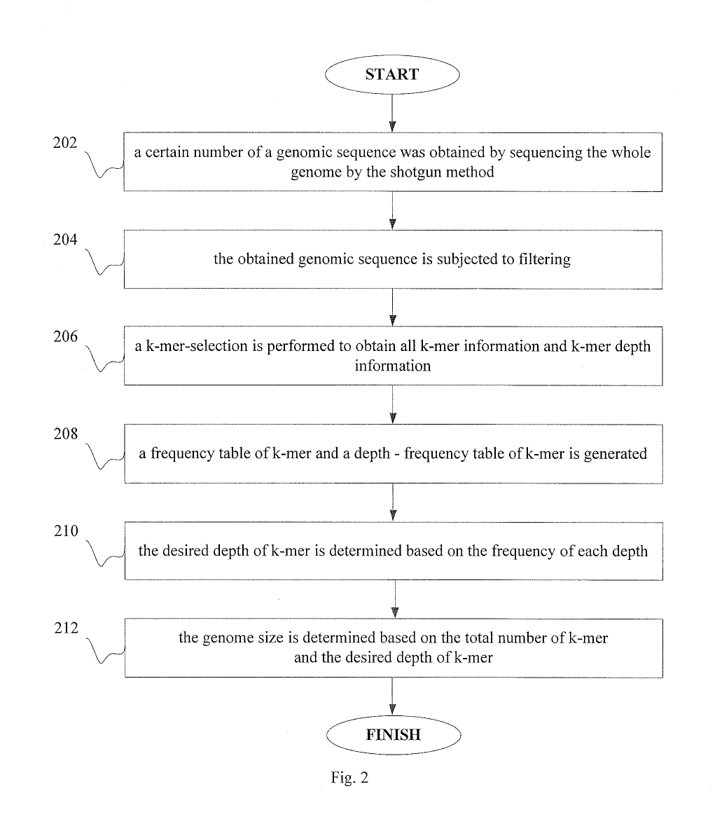

FIG. 2 shows a flow chart of a method of acquiring the genome size according to another embodiment of the present disclosure.

As shown in FIG. 2, in step 202, a whole genome is sequenced by shotgun method.

A certain number of a genomic sequence was obtained by sequencing the whole genome by the shotgun method (for example, the average times being sequenced of each base in the genome is 20 to 30).

In step 204, the obtained genomic sequence is subjected to filtering.

For example, the genomic sequence having low quality data is filtered out; the obtained genomic sequence having high quality data is then subjected to k-mer analysis. “filter out” refers to remove the genomic sequence having low quality using bioinformatics, i.e. in these genomic sequence having low quality, the base number having a sequencing quality being lower than a certain threshold exceeds the base number of intact sequence, such as 50%. The low quality threshold depends on the specific sequencing technique and the sequencing environment. During actual operation process, for raw sequencing data, usually there is a relative comprehensive filtering process, which comprises removing duplication and removing vector, while removing low quality data is usually conducted after the filtering processes.

In step 206, a k-mer-selection is performed to obtain all k-mer information and k-mer depth information.

The obtained genomic sequence is subjected to k-mer-selection based on a predetermined k-mer size (for example, the predetermined size is k) by means of moving forwardly base-wise. For example, the first k-mer is from the first site to the k site on the genomic sequence read; the second k-mer is from the second site to the k+1 site on the genomic sequence read, et al. The step of k-mer-selection is conducted until the k-mer-selection is conducted to all genomic sequences obtained by sequencing. The appearance time of each kind k-mer is recorded. So far, all k-mer information of sequence by sequencing and the appearance time of each kind number have been obtained; the appearance time of each k-mer is taken as the depth information of k-mer. The depth information of each k-mer calculated using a k-mer frequency table is described in the following part.

There are four conditions (A, T, C and G) for a specific site in a k-mer short sequence. Therefore, total 4^{k} kinds of k-mer may appear. In order to obtain the appearance time of each k-mer in a genomic sequence, an array having a size of 4^{k} may be set, such that the range of the array subscript (index) is 0˜4^{k} −1, and a memory occupied by the array having a size of 4^{k} is used to record the whole k-mer frequency table. The storage format is shown as follows:

{freq[seq0], freq[seq1], freq[seq 2], . . . , freq[seq(4^{k}−1)]}

The above shows the schematic allocation of the k-mer frequency table with the memory having a size of total 4^{k}, in which seq0, seql and the like are the subscripts of the array, and also represent the short sequence fragments with a sequence value having a value of subscript. The method for calculating the sequence value is that one nucleic acid sequence is stored using two bits (binary system), with A represented by 00, C represented by 01, G represented by 10, and T represented by 11. For example, a sequence of ATCG is represented by 00110110 using binary system, and after being converted, the sequence of ATCG is represented by 54 using decimal system, (2⁰×0+2¹×1+2²×1+2³×0+2⁴×1+2⁶×1+2⁶×0+2²×0=54) ᵢ.ₑ._{the sequence} value is 54.

To accelerate the calculation, different processes are used to access different regions of the frequency table in an embodiment, to perform sequence truncation and frequency calculation or the like in parallel, in which each process only processes a certain sequence value. When the sequence value in a buffer region is subjected to processing, a remainder is obtained by dividing the sequence value by a process number, to determine the sequence value should be processed using which process. For example, if a sequence value is 54 and a process number is 5 (process No.: 0, 1, 2, 3, 4), then the reminder is 4 obtained by dividing the sequence value 54 by the process number 5, and then this sequence should be subjected to the process with a process No. 4. After the process is determined, an array element with corresponding subscript equal to the sequence value in the frequency table is subjected to accumulatively updating using the determined process. Each process is only responsible for updating a value in the frequency table corresponding to a certain sequence value, to guarantee that processes are exclusive and do not interfere with each other, and also to ensure the uniqueness and accuracy of the updated results. Thus, the sequence values may be processed in parallel and the processing speed may be accelerated.

In a DNA sequence, a sequence and its reverse complementary sequence are two sequences having substantially the same biological information. Thus, when being calculated, the short sequence fragment and the reverse complementary sequence thereof are stored together, i.e. when a short sequence fragment is obtained, the reverse complementary sequence thereof is also calculated. A position of the array element represented by the lower value between the obtained two values is used to store the frequency of the short sequence fragment. For example, if a sequence fragment ATGCA has a sequence value of 228, then the reverse complementary sequence thereof TGCAT has a sequence value of 914. Therefore, the position of the array element having the sequence value of 228 is selected to store the frequency of the sequence fragment. Considering the reverse complementary sequence of a short sequence fragment having a length of an even number may be the short sequence fragment itself, for example, the reverse complementary sequence of a short sequence fragment GATC is GATC itself. To avoid this confusion, the short sequence fragment k-mer may be set to have a length of an odd number.

It should be noted that, the memory occupied by the array having a size of 4^{k} described above depends on the bit number occupied by each array element. To control the memory occupied by the array, each array element may be set to occupy one byte, i.e. each array element having a size of 8 bit, thus, the maximal frequency that can be calculated is 255 (2⁸−1). Here, the appearance time of each short sequence fragment stored by 8 bit is maximum 255, without accumulation exceeding 255. Of course, each array element can also be set to occupy 2 bytes or more.

In step 208, a depth-frequency table of k-mer or a depth-depth product frequency table of k-mer is generated.

Based on the k-mer information and the depth information of k-mer obtained in 206 step, a frequency corresponding to each depth value is calculated to generate the depth-frequency table of k-mer. For example, if there are totally t specific k-mers having a depth value of m, then the frequency corresponding to the depth value of m is t. The format of the depth-frequency table is illustrated as follows:

TABLE 1

| depth value | frequency |
|---|---|
| m | t |
| . . . | . . . |

The depth-depth product (depth value frequency*depth value) frequency table of k-mer may also be generated. For example, there are totally t specific k-mers having a depth value of m, then the depth product frequency corresponding to the depth value of m is t*m. The format of the depth-depth product frequency table is illustrated as follows:

TABLE 2

| depth value | depth product frequency |
|---|---|
| m | m × t |
| . . . | . . . |

In step 210, a desired depth of k-mer is determined based on the frequency information of each depth.

A depth curve and a depth product curve of k-mer are plotted, respectively. The depth distribution curve of k-mer (depth value-depth value frequency refers to a kinds number of k-mer at each depth value) and the depth product curve of k-mer (depth value-depth value frequency*depth value refers to the number of k-mers distributed at each depth value) are plotted based on the k-mer frequency table. Both curves may be used to estimate the size of a genome and to preliminarily estimate error rate and heterozygosis rate and the like. After verified by simulation data, the k-mer depth distribution curve is usually used for its comparatively low deviation rate.

In step 212, the genome size is determined based on a total number of k-mer and the desired depth of k-mer.

G is defined as the genome size, k is the length of k-mer, kₙᵤₘ is the total number of k-mer, K_{depth} is the desired depth of k-mer, bₙᵤₘ is the total number of sequencing base, rₙᵤₘ is the number of reads obtained by sequencing, and l is the average length of sequencing reads, thus

The desired depth of base is:

$${b}_{depth} = \frac{{b}_{num}}{G} \qquad ( 2 )$$

The desired depth of k-mer is

$${k}_{depth} = \frac{{k}_{num}}{G} \qquad ( 3 )$$

As the depth frequency distribution of k-mer obeys the Poisson distribution, the depth at the main peak of the depth curve of k-mer may be taken as the desired depth of k-mer, to estimate the genome size. The following formula is used:

$$G = \frac{{b}_{num}}{{b}_{depth}} = \frac{{k}_{num}}{{k}_{depth}} \\ {k}_{num} = {r}_{num} \times ( l - k + 1 ) \\ {b}_{num} = {r}_{num} \times l \qquad ( 4 )$$

In the above embodiment, the step of filtering the genome sequence obtained by sequencing may improve the accuracy of the result, and the step of processing the frequency table of k-mer may accelerate the processing speed and reduce the requirement of memory. The method of processing in parallel may also accelerate the processing speed.

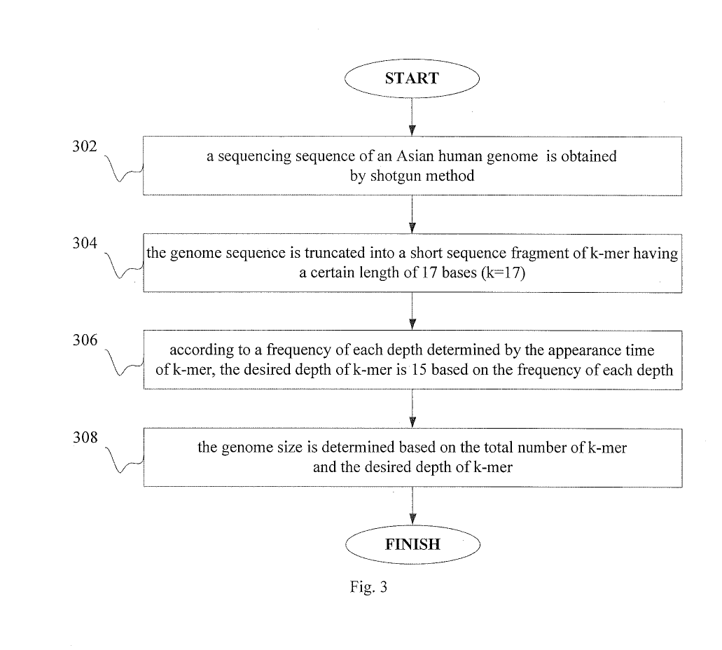

FIG. 3 shows a flow chart of a method of acquiring a genome size according to one application example of the present disclosure. In the application example, a short sequence fragment of k-mer having a certain length of bases are obtained by respectively truncating the received sequencing sequence by means of moving forwardly base-wise, then the total appearance times of various short sequence fragments of k-mer are calculated and taken as the depths of k-mer, and then the kinds number of short sequence fragments of k-mer corresponding to each depth are calculated. The specific process is shown as follows: In step 302, a sequencing sequence of an Asian human genome (also called Yanhuang genome) is obtained by shotgun method. The average length of sequencing sequence is 41 bases. Then the sequence was subjected to filtering out a data having a low-quality, i.e. the number of bases having a sequencing quality value less than 5 exceeding 50% of the total number of bases of the whole sequence is regarded as the data having the low-quality, and then a data having a high-quality is obtained for further analysis.

In step 304, the genome sequence is truncated into a short sequence fragment having a certain length of 17 bases (k=17). The length of short sequence fragment used herein is a reasonable value obtained by calculation and analysis. 417 is 16G with respect to the size of human genome (3.1G), 16G is enough to distinguish repetitive sequence, and occupies a reasonable size of memory. The received sequencing sequences are respectively truncated into a short sequence fragment having a certain length of 17 bases by means of moving forwardly base-wise. (for example, the first k-mer is from the first site to the seventeenth site, the second k-mer is from the second site to the eighteenth site . . . ). The number of possible type that may appear is 417 in total. The appearance time of each type of the short sequence fragments of k-mer is recorded. In step 306, according to a frequency table of the appearance time of the short sequence fragments of k-mer recorded in step 304, the kinds number of the short sequence fragment of k-mer corresponding to each depth is calculated, then a depth-frequency table is generated finally, and the frequency is output in accordance with an order from small to large.

When the frequency table of k-mer is subjected to constructing, according to the length of the short sequence fragment of 17 bases, and four kinds of characters A, T, C, G of the short sequence fragment, which have been set previously, there are 417 types in total of the short sequence which may appear, namely 16G The appearance time of each type of short sequence fragment in the sequence is firstly obtained by the frequency table of k-mer, to obtain this information, a used solution is to provide a character array having a size of 16G thus, the range of the array subscript is 0˜417-1, the size of each array element is 8 bit, and then the maximum frequency can be calculated is 255 (28−1). Here the appearance time of each type short sequence fragment is stored by 8 bits (the maximum is 255, without accumulation exceeding 255), and a memory having a size of 16G in total is used to record the whole frequency table of k-mer (FIG. 2), the format of storage is detailed described in the summary part.

In an embodiment of the present disclosure, 8 process tables are established (i.e. each sequence value of k-mer is corresponding to its frequency). A certain number of original sequences are input, and then the input original sequencing sequence is subjected to a multi-process of truncation and calculation of complementary sequence to the short sequence fragment using the 8 processes. After the data collection is completed, the frequency table is updated using the 8 processes, the specific method is detailed described in the summary part. The sequence values of k-mer and its reverse complementary sequence are both respectively calculated, and the two obtained sequence values are compared. The frequency value represented by the array element with the array subscript corresponding to the smaller sequence value in the frequency table is added with 1, if the value is 255, the accumulation operation is abandoned. A kind number table of frequency-short sequence fragment kind is generated, and species number table is output in accordance with the frequency value from small to large. After the assembly data of Yanhuang genome is selected and subjected to error correction, sequences having a data amount of 66G bases are truncated into the short sequence fragment having the certain length of 17 bases, the total number of the short sequence fragment is 46G; which may decrease the memory occupied by processing and the processing time.

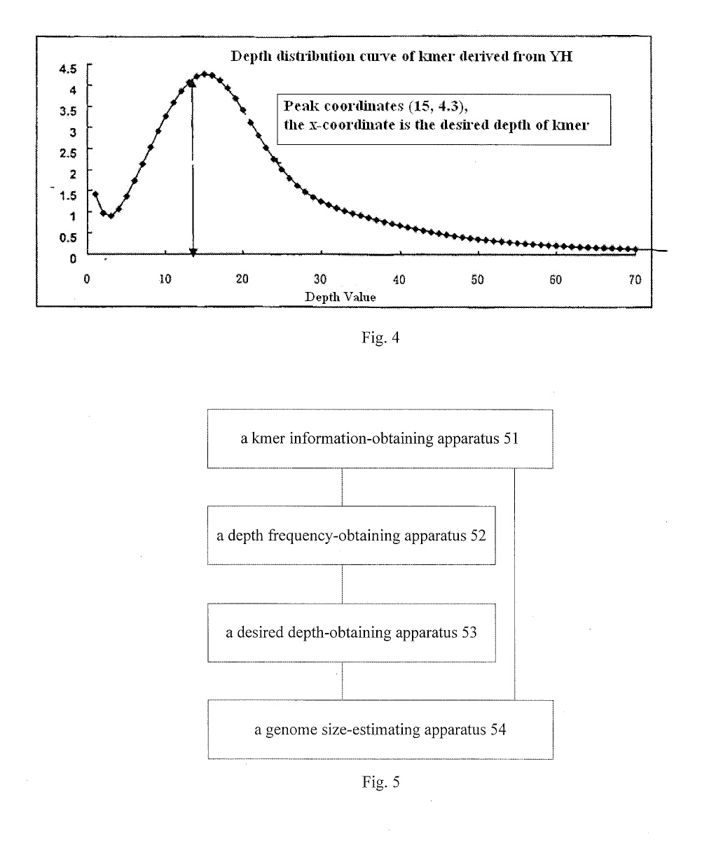

In step 308, based on the method and the formula of principle in summary, the genome size is estimated. The above steps are calculated, the number of k-mer obtained by the method according to the present disclosure is k_{numb}=46426574025, the desired depth of k-mer may be obtained from FIG. 4, i.e. k_{depth}=15, the above two values are taken into the formula:

$$G = \frac{{k}_{num}}{{k}_{depth}} = \frac{46426574025}{15} = 3.1 G$$

The human genome size is 3.1G, which is in conformity with the fact. Therefore, the method of the present disclosure has a comparatively high accuracy in terms of estimating the size of genome.

FIG. 5 shows a schematic diagram of a system of acquiring a genome size according to an embodiment of the present disclosure. As shown in FIG. 5, the system comprises a k-mer information-obtaining apparatus 51, a depth frequency-obtaining apparatus 52, a desired depth-obtaining apparatus 53 and a genome size-estimating apparatus 54, in which the k-mer information-obtaining apparatus 51 is configured to subject a certain number of a genomic sequence obtained by sequencing a whole genome to k-mer-selection, to obtain all k-mer information and a depth information of k-mer, the depth frequency-obtaining apparatus 52 is configured to obtain a frequency of each depth value based on the k-mer information and the depth information of k-mer, the desired depth-obtaining apparatus 53 is configured to determine a desired depth of k-mer based on the frequency of each depth value, and the genome size-estimating apparatus 54 is configured to estimate the genome size G upon a total number of k-mer and the desired depth of k-mer:

$$G = \frac{{k}_{num}}{{k}_{depth}} \qquad ( 5 )$$

in which is the total number of k-mer, k_{depth} is the desired depth of k-mer.

In an embodiment of the present disclosure, the total number of k-mer (kₙᵤₘ) is obtained using system for acquiring a genome size based on the formula shown below:

kₙᵤₘ=rₙᵤₘ×(l−k+1) (6)

in which rₙᵤₘ represents the number of short sequence reads obtained by sequencing, l represents an average length of sequencing reads, and k represents the length of k-mer.

The method of acquiring the genome size according to embodiments of the present disclosure may estimate the length of an intact sequence using the short sequence obtained by sequencing (also known as reads) combining with assembling the short sequence fragment, which may reflect the genome size. In recently years, the research method based on genome sequencing and assembly is increasing popular. In this context, a new method of estimating the genome size-genomic k-mer study (k-mer: a sequence having a consecutive bases length of k) is provided in the present disclosure. In a genome, the distribution of k-mer is closely related to the size, error rate and heterozygosis rate of the genome. The method provided in the present disclosure calculates and analyzes the distribution of k-mer in reads based on the statistical principle and further estimates the size, error rate, heterozygosis rate and the like of the genome.

The method of the present disclosure has the following advantages comparing to the conventional cytobiological method: (1) The method of the present disclosure may conveniently and quickly estimate the genome size, and save the resources spent by experimental technique of the conventional method. By the k-mer analysis method of estimating the genome size, the resource needed is only sequencing sequence, and all analysis are performed based on the frequency table of k-mer of the sequencing sequence and the depth-frequency curve of k-mer of the sequencing sequence, the sequencing sequence is an inevitable product during the process of genome sequencing, there is no extra requirements of experimental technique and the like. Comparing the relatively high requirement with experimental equipment and biological experimental technique of the conventional method, the present technical solution may obtain a relative more accurate result of estimating the genome size, more importantly; the present technical solution may perform an adjustment with different influencing factors based on a special situation of the genome, and then the estimation of genome size is obtained which is closer to the true value.

(2) The estimated genome size is closer to the true value. Regarding the subsequent sequence assembly, estimating the genome size in advance may be used to direct the design of sequencing strategy and the evaluation of assembly result.

Based on the depth distribution curve of k-mer and depth product curve of k-mer, in addition to estimating the genome size, an error rate of the sequencing sequence may also be estimated.

The principle for estimating the error rate of the sequencing sequence is that: starting from the frequency of k-mer having a depth of 1, for a k-mer having a length of k, supposing that 1 inaccurate base may cause ε×k specific k-mers averagely; then the following formula may be obtained:

$${\hat{P}}_{1} = {P}_{1} + \frac{{n}_{b} \times f \times ɛ \times k}{{n}_{k}} = \frac{{n}_{1}}{{n}_{k}} \qquad ( 7 )$$

in which, \hat{P}₁ is an observation value of frequency having a depth of 1, P₁ is an actual value without an influence of error, f is an error rate, n_{b} is the total number of bases, nₖ is the total number of k-mer, n₁ is the number of k-mer having a depth of 1, and ε is a probability value of an inaccurate base obtained by the error rate, which is related to a characteristic of repetitiveness of the sequence and a margin of the sequence, and also has a certain relationship with the depth but has little effect.

As the depth frequency of k-mer is subject to the Poisson distribution, thus P(X=1)=λ×e^{-λ}, in which λ is the desired depth of the peak value. Due to λ usually less than 100, thus with an increase of λ, the probability at a depth of 1 decreases. When λ=10, the value is 0.045%, However, the error rate usually causes the frequency at the depth of 1 to reach 40%, which exists 1000 times difference of 0.045%. Thus, this influence may not need to be considered.

The following formula for calculating the error rate is thus obtained:

$$\begin{matrix}f = \frac{{n}_{k}}{{n}_{b} \times ɛ \times k} \times ( {\hat{P}}_{1} - {P}_{1} ) \\ \approx \frac{{n}_{k}}{{n}_{b} \times ɛ \times k} \times {\hat{P}}_{1} \\ = \frac{{n}_{1}}{{n}_{b} \times ɛ \times k}\end{matrix} \qquad ( 8 )$$

in which ε usually needs estimation of simulation test of closely related species, for example, ε value of Arabidopsis is about 0.5, which may be used to estimate an error rate of sequencing closely related species, such as The llungiella halophila, cabbage, etc.

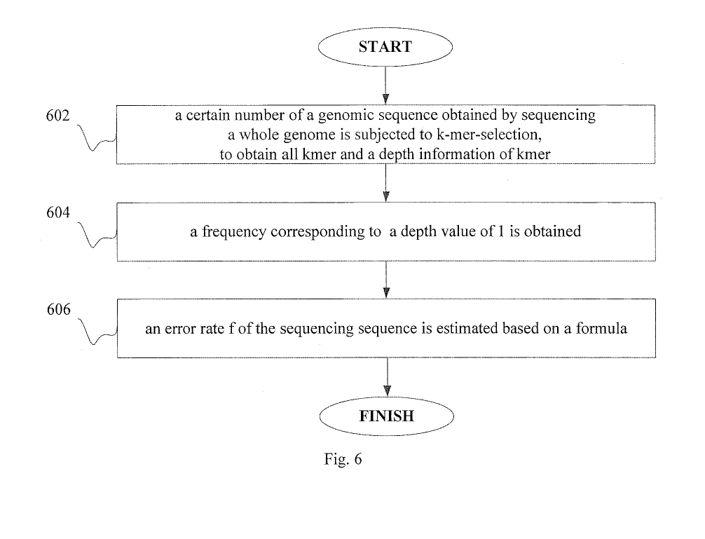

FIG. 6 shows a flow chart of a method of estimating an error rate of sequencing a sequence according to an embodiment of the present disclosure.

As shown in FIG. 6, in step 602, all k-mer information and the depth information of k-mer are obtained by subjecting a certain number of a genome sequence obtained by sequencing a whole genome to k-mer-selection.

In step 604, the frequency of k-mer having a depth value of 1 is obtained.

In step 606, an error rate f the sequencing sequence is determined using the following formula:

$$f = \frac{{n}_{1}}{{n}_{b} \times ɛ \times k} \qquad ( 9 )$$

in which n₁ is a frequency of k-mer having a depth value of 1, n_{b} is the total number of bases, ε is a probability value of an inaccurate base obtained by an error rate, and k is a length of k-mer.

In the above embodiment, the genome size is estimated base on the frequency table of k-mer, thus the error rate is sensitive to an influence of the frequency of k-mer. By means of this characteristic may preliminary estimate the error rate of the sequencing sequence by the content of k-mer having a low frequency; and preliminary evaluate the sequencing quality, which may provide a reference for subsequent error correction of the sequencing sequence and genome assembly. Based on the depth distribution of k-mer and the depth product distribution of k-mer, in addition to estimating the genome size, a heterozygosis rate of the genome may also be estimated, and an analysis may also performed with the characteristic of repetitiveness of genome. A method of estimating a heterozygosis rate of genome is introduced below: the length of k-mer is supposed to be k, the genome size is supposed to be G, and then the number of specific k-mers is G. The number of snp is n, and the snp rate is

$$η = \frac{n}{G} . {\hat{p}}_{\frac{1}{2}}$$

is an observation probability of a heterozygous peak in a heterozygous condition, \hat{P} is an observation probability of a main peak in a certain heterozygous condition, P is a probability of a main peak in a non-heterozygous condition, and

$${p}_{\frac{1}{2}}$$

is a probability at a half way of the main peak in a non-heterozygous condition. Thus, the following formula exists:

$$\begin{matrix}G \times {\hat{p}}_{\frac{1}{2}} = G \times {p}_{\frac{1}{2}} + \frac{2 \times k \times n}{ɛ} & ( 10 ) \\ G \times \hat{p} = G \times p - k \times n & ( 11 )\end{matrix}$$

So, the change ratio of heights between the main peak and heterozygous peak is:

$$\frac{Δ {p}_{\frac{1}{2}}}{Δ p} = \frac{{\hat{p}}_{\frac{1}{2}} - {p}_{\frac{1}{2}}}{p - \hat{p}} = \frac{2}{ɛ} ,$$

and the heterozygosis rate is:

$$η = \frac{n}{G} = \frac{p - \hat{p}}{k} ,$$

in which ε in this formula is related to the characteristic of repetitiveness of genome, which is different from the ε in the analysis of error rate. One repetitiveness level is corresponding to one unit of ε, which determines one change rate of peak height. In addition, as the true sequencing date is accompanied by the influence of error rate, the calculating formula of heterozygosis rate plays a little role in the practical estimation.

Thus, a hypothesis is proposed: given a certain basic peak height and a certain change ratio of the peak height, then a final possible peak height and peak height rate is determined.

Accordingly, from the peak height of zero heterozygous curve to the peak height of target curve, the change rate of the peak height is determined, the characteristic of repetitiveness is required to be adjusted, to make the change rate of the peak height in the circumstance of adding a certain heterozygosis being equal to the change rate of the peak height from the zero heterozygous curve to the target curve. Namely,

$$\frac{{\hat{p}}_{\frac{1}{2}} - {p}_{\frac{1}{2}}^{0}}{{p}^{0} - \hat{p}} = \frac{{\hat{p}}_{\frac{1}{2}}^{′} - {p}_{\frac{1}{2}}^{0}}{{p}^{0} - {\hat{p}}^{′}}$$

For the k-mer curve constructed for actual species,

$${\hat{p}}_{\frac{1}{2}}$$

and {circumflex over (\hat{P} are known. For the similar species, in the circumstance of adding no heterozygosis, P and

$${p}_{\frac{1}{2}}$$

are known, which results in one corresponding ε. To estimate the heterozygosis rate, the repetitiveness level of simulation species must be adjusted, to adjust ε, which makes the equation holding in the circumstance of adding a certain heterozygosis rate (\hat{P}′ and

$${\hat{p}}_{\frac{1}{2}}^{′}$$

are obtained), then heterozygosis rate is adjusted, finally, the obtained observation peak height is equal to an actual species in the circumstance of adding a same heterozygosis rate. Based on the above analysis, an idea of estimating a heterozygosis rate is provided:

selecting closely related species, to ensure the values of E being as close as possible;

estimating an error rate, and simulating in the circumstance of a similar error rate, to exclude an influence of the error rate; adjusting an influence of a repetitiveness level, i.e. adjusting ε, to make the equation holding, i.e. the repetitiveness level is close;

adding heterozygosis rate and examining whether the E value obtained by adding the adjustment the repetitiveness level meets the requirement of peak height overlapping.

The existence of the genome heterozygosis rate and the repetitive sequence is a huge challenge for the short sequence assembling technology obtained by the Next-Generation sequencing technology, since the influence of the genome heterozygosis rate and the repetitive sequence may lead to a very unsatisfactory assembly result of short sequence. The k-mer analysis may preliminary determine the heterozygosis rate and the repetitiveness level of the genome, to direct the assembling technician to adjust the assembly strategy, which may conveniently and rapidly make an adjustment of sequencing strategy and assembly strategy.

The description of the present disclosure is provided for explanatory and illustration, but is not exhaustive or constructed to the disclosed forms of the present disclosure. Various kinds of changes and alterations are obvious for those people skilled in the art. The selection and description of embodiments aim to better explain the principle and practical application of the present disclosure, and to make those skilled in the art understood the disclosure to design various embodiments with various modifications suitable for specific uses.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method of acquiring a genome size comprising:
subjecting a certain number of a genomic sequence obtained by sequencing a whole genome to k-mer-selection, to obtain all k-mer information and a depth information of k-mer;
obtaining a frequency of each depth value based on the k-mer information and the depth information of k-mer;
determining a desired depth of k-mer based on the frequency of each depth value;
estimating the genome size G based on a total number of k-mer and the desired depth of k-mer:
$$G = \frac{{k}_{num}}{{k}_{depth}}$$
wherein kₙᵤₘ is the total number of k-mer, k_{depth} is the desired depth of k-mer.

2. The method of claim 1, wherein the certain number of the genomic sequence indicates that the number of each base in the genome being sequenced is 10˜20, 20˜30, or more.

3. The method of claim 1, wherein subjecting the certain number of the genomic sequence obtained through sequencing the whole genome to k-mer- selection comprises:
subjecting the certain number of the genomic sequence obtained by sequencing the whole genome to k-mer-selection based on a predetermined k-mer size by means of moving forwardly base-wise.

4. The method of claim 1, wherein obtaining the all k-mer information and the depth information of k-mer comprises:
allocating an array in a size of 4^{k}, wherein k is a length of k-mer;
determining an index of the array corresponding to a k-mer based on a base information of the k-mer; and
calculating a frequency of the k-mer in the array corresponding to the k-mer.

5. The method of claim 4, wherein the k-mer information and the depth information of k-mer are obtained by parallel statistical calculation.

6. The method of claim 1, wherein the total number of k-mer kₙᵤₘ is obtained based on following formula:
kₙᵤₘ=rₙᵤₘ×(l−k+1)
wherein rₙᵤₘ represents the number of short-sequence reads obtained by sequencing, 1 represents an average length of sequencing reads, and k represents the length of k-mer.

7. The method of claim 1, further comprising:
subjecting the genomic sequence obtained by sequencing the whole genome to filtering.

8. A system for acquiring a genome size comprising:
a k-mer information-obtaining apparatus, configured to subject a certain number of a genomic sequence obtained by sequencing a whole genome to k-mer-selection, to obtain all k-mer information and a depth information of k-mer;
a depth frequency-obtaining apparatus, configured to obtain a frequency of each depth value based on the k-mer information and the depth information of k-mer;
a desired depth-obtaining apparatus, configured to determine a desired depth of k-mer based on the frequency of each depth value;
a genome size-estimating apparatus, configured to estimate the genome size G upon a total number of k-mer and the desired depth of k-mer:
$$G = \frac{{k}_{num}}{{k}_{depth}}$$
wherein kₙᵤₘ is the total number of k-mer, k_{depth} is the desired depth of k-mer.

9. The system of claim 8, wherein the total number of k-mer kₙᵤₘ is obtained by the genome size-estimating apparatus based on following formula:
kₙᵤₘ=rₙᵤₘ×(l−k+1)
wherein rₙᵤₘ represents the number of short-sequence reads obtained by sequencing, 1 represents an average length of sequencing reads, and k represents the length of k-mer.

10. A method of estimating an error rate of sequencing a sequence, comprising:
subjecting a certain number of a genomic sequence obtained by sequencing a whole genome to k-mer-interception, to obtain all k-mer information and a depth information of k-mer;
obtaining a frequency of k-mer having a depth value of 1;
determining the error rate f of sequencing the sequence based on following formula:
$$f = \frac{{n}_{1}}{{n}_{b} \times ɛ \times k}$$
wherein n₁ is the frequency of k-mer having the depth value of 1, n_{b} is the total number of bases, ε is a probability value of error base produced by the error rate, k is the length of k-mer.

11. The method of claim 10, wherein ε is 0.5.
